(19) United States
(12) Patent Application Publication
(10) Pub. No.: US 2023/0305121 A1
(43) Pub. Date: Sep. 28, 2023

(54) METHOD, PROCESSOR, AND LASER RADAR SYSTEM FOR FILTERING OUT INTERSTITIAL POINTS IN RADAR POINT CLOUD

(71) Applicant: HESAI TECHNOLOGY CO., LTD., Shanghai (CN)

(72) Inventors: Wenxiang WANG, Shanghai (CN); Congbo SHI, Shanghai (CN); Shaoqing XIANG, Shanghai (CN)

(73) Assignee: HESAI TECHNOLOGY CO., LTD., Shanghai (CN)

(21) Appl. No.: 18/325,156

(22) Filed: May 30, 2023

Related U.S. Application Data
(63) Continuation of application No. PCT/CN2021/101982, filed on Jun. 24, 2021.

(30) Foreign Application Priority Data
Dec. 4, 2020 (CN) 202011400280.7

(51) Int. Cl. G01S 7/487; G01S 17/89

(52) U.S. Cl. CPC G01S 7/4876; G01S 17/89

(57) ABSTRACT

A method, a processor, and a laser radar system for filtering out interstitial points in a radar point cloud includes: for a to-be-recognized point in a point cloud, acquiring, from point cloud information, ranging information of the to-be-recognized point, ranging information of one or more auxiliary points at the first side of the to-be-recognized point, and ranging information of one or more auxiliary points at the second side of the to-be-recognized point; determining, based on the ranging information of the to-be-recognized point, whether the to-be-recognized point is an interstitial point; and filtering out the to-be-recognized point if the to-be-recognized point is the interstitial point.

### CROSS-REFERENCE TO RELATED APPLICATIONS

This application is a bypass Continuation of International Patent Application No. PCT/CN2021/101982, filed Jun. 24, 2021, which claims priority to Chinese Patent Application No. 202011400280.7, filed Dec. 4, 2020; the disclosure of all of which are incorporated herein by reference in their entirety.

### TECHNICAL FIELD

The present disclosure relates to the field of laser radar, and in particular, to a method, a processor, and a laser radar system for filtering out interstitial points in a radar point cloud.

### BACKGROUND

An interstitial point is a phenomenon that after a light spot of the same light emitted by a radar simultaneously lightens edges of two objects close to each other and echoes are superimposed, a leading edge and a pulse width are inaccurate, to form ordinary points of a connection line between the objects.

FIG. 1 is a schematic diagram of a formation principle of interstitial points according to the prior art. As shown in FIG. 1, a Light Detection and Ranging (LiDAR) system, also referred to as laser radar, emits a detection pulse which is incident on edges of a first object and a second object which are close in front and back, part of the detection pulse on the first object is diffusely reflected, and some reflection echoes return to the laser radar and are received by a photoelectric detector of the laser radar. Part of the detection pulse on the second object is diffusely reflected, and some reflection echoes return to the laser radar and are received by the photodetector of the laser radar. Therefore, for a detection pulse transmitted by the laser radar, two echoes are generated, and the two echoes are both received by the photodetector of the laser radar. FIG. 2 is a schematic diagram of a radar point cloud including the interstitial points according to the prior art. As shown in FIG. 2, when the laser radar generates a point cloud, interstitial points are formed between the first object and the second object as shown in an oval, and therefore it may be mistakenly considered that other target objects further exist between the first object and the second object. The phenomenon of an interstitial point may lead to the inaccurate echo leading edge and pulse width, which may affect a time of flight (TOF) and cause inaccurate measurement (a leading edge and a pulse width of an echo pulse are mainly used for measuring the TOF).

FIG. 3 is a schematic diagram of clustering of points according to the prior art. As shown in FIG. 3, the existing method for filtering out an interstitial point is usually performing clustering, such as performing clustering according to a reflectivity, a relative position between points, or the like, and filtering out interstitial points included in the points by filtering out discrete points that do not meet the clustering condition. This method has high complexity of algorithm and low efficiency.

### SUMMARY

The present disclosure is intended to provide a method, a processor, and a laser radar system for filtering out interstitial points in a radar point cloud. In this way, by making full use of the ranging characteristics of the laser radar, whether points are interstitial points is determined according to ranging information of the points, such that the interstitial points in the radar point cloud can be effectively filtered out. Moreover, the logic for determination is direct, the complexity of computation is low, and the efficiency is relatively high.

The present disclosure discloses a method for filtering out the interstitial points in a radar point cloud. The method comprises:
for a to-be-recognized point in the point cloud, acquiring, from point cloud information, ranging information of one or more auxiliary points at the first side and ranging information of one or more auxiliary points at the second side of the to-be-recognized point, where a timing span between an auxiliary point at the first side farthest away from the to-be-recognized point and the to-be-recognized point or between an auxiliary point at the second side farthest away from the to-be-recognized point and the to-be-recognized point is related to an angular resolution of a radar;
determining, based on the ranging information of the one or more auxiliary points at the first side and the ranging information of the one or more auxiliary points at the second side, whether the to-be-recognized point is the interstitial point; and
filtering out the to-be-recognized point if the to-be-recognized point is the interstitial point.

Optionally, the timing span between the auxiliary point at the first side farthest away from the to-be-recognized point and the to-be-recognized point is equal to a number of the one or more auxiliary points at the first side times a multiple of a maximum angular resolution and a minimum angular resolution of the radar, or the timing span between the auxiliary point at the second side farthest away from the to-be-recognized point and the to-be-recognized point is equal to a number of the one or more auxiliary points at the second side times a multiple of a maximum angular resolution and a minimum angular resolution of the radar.

Optionally, the determining, based on the ranging information of the one or more auxiliary points at the first side and the ranging information of the one or more auxiliary points at the second side, whether the to-be-recognized point is the interstitial point further comprises:
determining, based on the ranging information of the auxiliary point of the first side closest to the to-be-recognized point and the ranging information of the auxiliary point of the second side closest to the to-be-recognized point, whether the auxiliary point of the first side closest to the to-be-recognized point and the auxiliary point of the second side closest to the to-be-recognized point are located on the same object, wherein the to-be-recognized point is located between the auxiliary point of the first side closest to the to-be-recognized point and the auxiliary point of the second side closest to the to-be-recognized point; and
if the auxiliary point at the first side closest to the to-be-recognized point and the auxiliary point at the second side closest to the to-be-recognized point are located on the same object, the to-be-recognized point is not the interstitial point.

Optionally, if the distance of the to-be-recognized point is between the distance corresponding to the auxiliary point the first side closest to the to-be-recognized point and the distance corresponding to the auxiliary point at the second side closest to the to-be-recognized point, the to-be-recognized point is located between the auxiliary point at the first side closest to the to-be-recognized point and the auxiliary point at the second side closest to the to-be-recognized point.

Optionally, if the auxiliary point at the first side closest to the to-be-recognized point and the auxiliary point at the second side closest to the to-be-recognized point are not located on the same object,
it is determined based on the ranging information of a plurality of auxiliary points at the first side and the ranging information of a plurality of auxiliary points at the second side whether the plurality of auxiliary points at the first side are located on a first object and whether the plurality of auxiliary points at the second side are located on a second object; and
if the plurality of auxiliary points at the first side are located on the first object and the plurality of auxiliary points at the second side are located on the second object, the to-be-recognized point is the interstitial point.

Optionally, if the ranging information of the plurality of auxiliary points at the first side is all 0 or the ranging information of the plurality of auxiliary points at the second side is all 0, the to-be-recognized point is not the interstitial point.

Optionally, the to-be-recognized point, the one or more auxiliary points at the first side, and the one or more auxiliary points at the second side are all within a maximum threshold distance.

Optionally, if the auxiliary point at the first side of the to-be-recognized point closest to the to-be-recognized point and the auxiliary point at the second side of the to-be-recognized point closest to the to-be-recognized point are located on the same object, the method further comprises:
determining, based on the ranging information of the to-be-recognized point, the ranging information of the auxiliary point at the first side closest to the to-be-recognized point, and the ranging information of the auxiliary point at the second side closest to the to-be-recognized point, whether the to-be-recognized point is close to the auxiliary point at the first side closest to the to-be-recognized point or whether the to-be-recognized point is close to the auxiliary point at the second side closest to the to-be-recognized point, where
if the to-be-recognized point is close to the auxiliary point at the first side closest to the to-be-recognized point or the to-be-recognized point is close to the auxiliary point at the second side closest to the to-be-recognized point, the to-be-recognized point is not the interstitial point.

Optionally, all points in the point cloud are successively used as the to-be-recognized point to perform the steps of the above method for recognition.

The present disclosure discloses a processor. The processor is configured to perform the method for filtering out the interstitial point in a radar point cloud.

The present disclosure discloses a laser radar system, comprising:
a transmitting device, configured to transmit a laser detection beam; and
a receiving device, configured to receive the detection beam and perform photoelectric conversion to obtain a corresponding point cloud; and further comprising:
a processor to perform the method for filtering out the interstitial point in a radar point cloud based on the point cloud.

Different from the prior art, the present disclosure has the following effects.

In the present disclosure, by making full use of the ranging characteristics of laser radar, whether points are interstitial points is determined according to ranging information of the points, such that the interstitial points in the radar point cloud can be effectively filtered out. Moreover, the logic for determination is direct, the complexity of computation is low, and the efficiency is relatively high.

### BRIEF DESCRIPTION OF THE DRAWINGS

FIG. 1 is a schematic diagram of a formation principle of interstitial points according to the prior art.

FIG. 2 is a schematic diagram of a radar point cloud comprising the interstitial points according to the prior art.

FIG. 3 is a schematic diagram of clustering of points according to the prior art.

FIG. 4 is a schematic diagram of a method for filtering out interstitial points in a radar point cloud according to an embodiment of the present disclosure.

FIG. 5 is a schematic diagram of a to-be-recognized point and one or more auxiliary points at the first side of the to-be-recognized point and one or more auxiliary points at the second side of the to-be-recognized point according to an embodiment of the present disclosure.

FIG. 6 is a schematic diagram of a method for determining the interstitial point according to an embodiment of the present disclosure.

FIG. 7 is another schematic diagram of a method for determining the interstitial point according to an embodiment of the present disclosure.

FIG. 8a is a schematic diagram of a radar point cloud in a state of enabling filtering-out of the interstitial points according to an embodiment of the present disclosure.

FIG. 8b is a schematic diagram of a radar point cloud in a state of disabling filtering-out of the interstitial points according to an embodiment of the present disclosure.

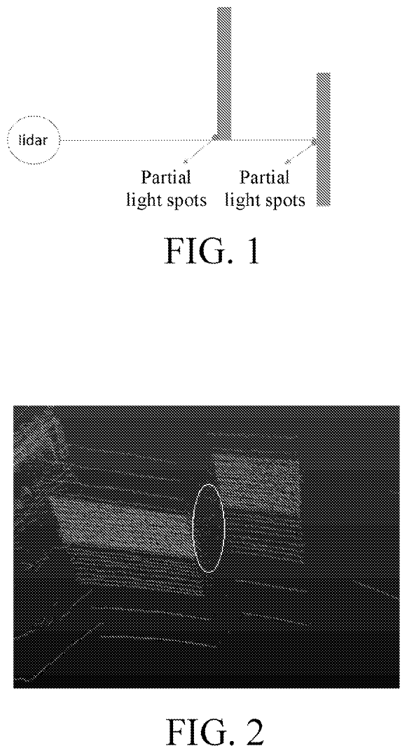

### DETAILED DESCRIPTION

In order to make the objectives and technical solutions of the embodiments of the present disclosure clearer, the technical solutions of the embodiments of the present disclosure will be clearly and completely described below with reference to the accompanying drawings of the embodiments of the present disclosure. Apparently, the described embodiments are some but not all of the embodiments of the present disclosure. Based on the described embodiments of the present disclosure, all other embodiments obtained by a person of ordinary skill in the art without creative efforts shall fall within the protection scope of the present disclosure.

A first implementation of the present disclosure relates to a method for filtering out interstitial points in a radar point cloud.

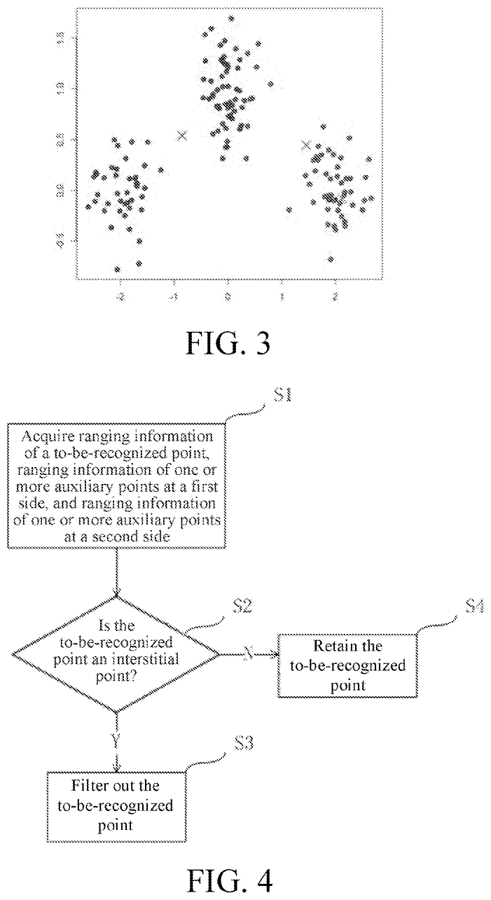

FIG. 4 is a schematic diagram of a method for filtering out interstitial points in a radar point cloud according to an embodiment of the present disclosure.

As shown in FIG. 4, the method for filtering out interstitial points in a radar point cloud comprises the following steps.

In step S1, for a to-be-recognized point in a point cloud, ranging information of the to-be-recognized point, ranging information of one or more auxiliary points at the first side of the to-be-recognized point, and ranging information of one or more auxiliary points at the second side of the to-be-recognized point are acquired from point cloud information. A timing span between an auxiliary point at the first side or the second side farthest away from the to-be-recognized point and the to-be-recognized point is related to an angular resolution of a radar.

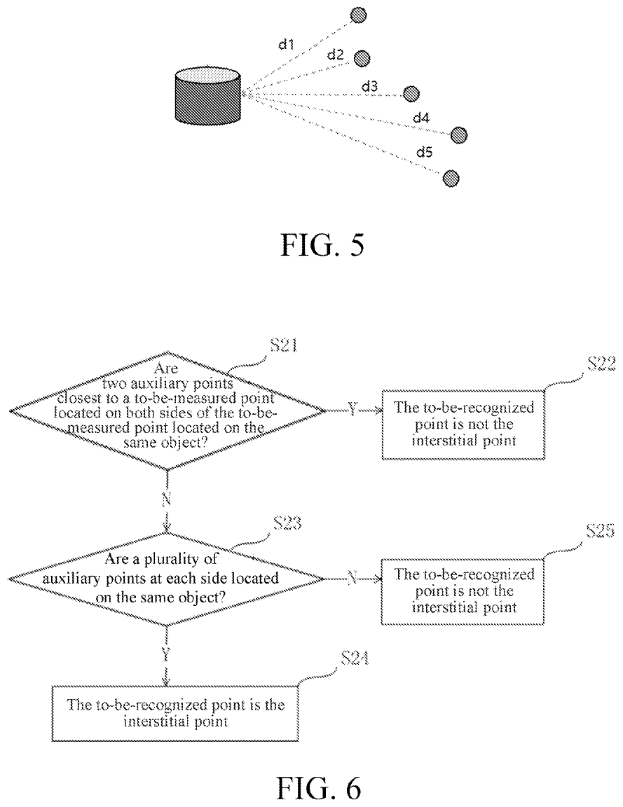

The ranging information of a point in the point cloud includes a distance d from the point to the radar. FIG. 5 is a schematic diagram of a to-be-recognized point and one or more auxiliary points at the first side of the to-be-recognized point and one or more auxiliary points at the second side of the to-be-recognized point according to an embodiment of the present disclosure. As shown in FIG. 5, the ranging information of the to-be-recognized point is d₃, the ranging information of one or more auxiliary points at the first side of the to-be-recognized point is respectively d₁ and d₂, and the ranging information of one or more auxiliary points at the second side of the to-be-recognized point is respectively d₄ and d₅.

All points in the point cloud are stored at a certain interval to form point cloud information, and each point is searched for at the interval. The timing span between points may be indicated by the storage span and/or search times between these two points. Specifically, the timing span between the auxiliary point at the first side or the second side farthest away from the to-be-recognized point and the to-be-recognized point is related to an angular resolution of a radar. More specifically, the timing span between the auxiliary point at the first side farthest away from the to-be-recognized point or the auxiliary point at the second side farthest away from the to-be-recognized point and the to-be-recognized point is equal to the number of the one or more auxiliary points at the first side or the second side times a multiple of a maximum angular resolution and a minimum angular resolution of the radar.

During storage, all points in the point cloud are stored at an interval of the minimum angular resolution (for example, 0.1°), that is, the points are spaced apart by the interval of 0.1° and are searched for at the interval. If it is necessary to respectively acquire the ranging information of two auxiliary points at the first side and the ranging information of two auxiliary points at the second side of the to-be-recognized point from the point cloud information, for example, since the number of one or more auxiliary points at the first side or the second side is 2, and the multiple of the maximum angular resolution and the minimum angular resolution of the radar is 4, the timing span between the auxiliary point at the first side farthest away from the to-be-recognized point or the auxiliary point at the second side farthest away from the to-be-recognized point and the to-be-recognized point is 8.

For example, a maximum horizontal angular resolution of a 64-line radar with a scanning range of 360° is 0.4° and a minimum horizontal angular resolution is 0.1°. In order to ensure a sufficient storage space, the point cloud information is stored at an interval of the minimum angular resolution of 0.1° in the storage structure, that is, 3600*64 storage locations are provided as storage locations of the point cloud information. If the radar adopts a scanning mode with an angular resolution of 0.4° in a certain region, for example, in the horizontal angle range of [200°, 320°], then actual point cloud information can be obtained every four storage locations at this time, and the corresponding timing span may be considered as 4.

In step S2, it is determined, based on the ranging information of the to-be-recognized point, the ranging information of the one or more auxiliary points at the first side, and the ranging information of the one or more auxiliary points at the second side, whether the to-be-recognized point is the interstitial point. In addition, if the to-be-recognized point is the interstitial point, step S3 of filtering out the to-be-recognized point is performed, or otherwise step S4 of retaining the to-be-recognized point is performed.

Referring to FIG. 6, FIG. 6 is a schematic diagram of a method for determining the interstitial point according to an embodiment of the present disclosure.

As shown in FIG. 6, the determining, based on the ranging information of the to-be-recognized point, the ranging information of the one or more auxiliary points at the first side, and the ranging information of the one or more auxiliary points at the second side, whether the to-be-recognized point is the interstitial point further comprises the following steps.

In step S21, it is determined based on the ranging information of the auxiliary point at the first side closest to the to-be-recognized point and the ranging information of the auxiliary point at the second side closest to the to-be-recognized point whether the auxiliary point of the first side closest to the to-be-recognized point and the auxiliary point of the second side closest to the to-be-recognized point are located on the same object.

The to-be-recognized point, one or more auxiliary points at the first side of the to-be-recognized point, and one or more auxiliary points at the second side of the to-be-recognized point may be located on a plate or a surface, and one or more points on the same object indicate that these points are located on the same plate or surface, or a distance difference between these plates or surfaces is within a threshold range although these points are located on different plates or surfaces. The shape of the plate or surface is not limited, but it is preferable that the plate or surface is as flat as possible, such as a flat plate or a plane. In addition, it is more preferable that the flat plate or the plane is perpendicular to an incident direction of the radar, since if an angle between the flat plate or the plane and the incident direction of the radar is excessively large or excessively small, the interstitial points may not be filtered out.

The to-be-recognized point is located between the auxiliary point at the first side closest to the to-be-recognized point and the auxiliary point at the second side closest to the to-be-recognized point. More specifically, if the distance of the to-be-recognized point is between the distance corresponding to the auxiliary point at the first side closest to the to-be-recognized point and the distance corresponding to the auxiliary point at the second side closest to the to-be-recognized point, the to-be-recognized point is located between the auxiliary point at the first side closest to the to-be-recognized point and the auxiliary point at the second side closest to the to-be-recognized point.

Referring to FIG. 5, as shown in FIG. 5, the ranging information of the auxiliary point at the first side closest to the to-be-recognized point is d₂, and the ranging information of the auxiliary point at the second side closest to the to-be-recognized point is d₄. If d₂<d₃<d₄ or d₂>d₃>d₄, that is, d₃ is between d₂ and d₄, the to-be-recognized point is located between the auxiliary point at the first side closest to the to-be-recognized point and the auxiliary point at the second side closest to the to-be-recognized point.

For step S21, it may be determined, based on relative distance relationships of the points, whether the points are located on the same object.

Preferably, a first determination threshold is set to dₜₕ₀. If |d₄−d₂|<dₜₕ₀, that is, a difference between d₂ and d₄ is less than dₜₕ₀, it can be considered that the auxiliary point at the first side closest to the to-be-recognized point and the auxiliary point at the second side closest to the to-be-recognized point are located on the same object. Since the auxiliary point at the first side closest to the to-be-recognized point and the auxiliary point at the second side closest to the to-be-recognized point are located on the same object, it can be determined that the to-be-recognized point between these two auxiliary points is also located on the same object, that is, the to-be-recognized point is not an interstitial point. The first determination threshold dₜₕ₀ can be determined according to the possible error of ranging or the surface unevenness. For example, the first determination threshold dₜₕ₀ is set as the minimum deviation value of current ranging, or the like.

In addition, a second determination threshold is set to dₜₕ₁. The second determination threshold dₜₕ₁ is used, in combination with the first determination threshold dₜₕ₀, to determine the positional relationship between the to-be-recognized point and the auxiliary point. Preferably, if dₜₕ₁≥|d₄−d₂|≥dₜₕ₀, that is, the difference between d₂ and d₄ is within the range of dₜₕ₀ to dₜₕ₁, it can be considered that the auxiliary point at the first side closest to the to-be-recognized point and the auxiliary point at the second side closest to the to-be-recognized point are not located on the same object.

The determination thresholds according to the embodiments of this application, such as dₜₕ₀, dₜₕ₁, dₜₕ₂, dₜₕ₃, and dₜₕ₄, can be determined based on statistical information of actual measured dimensions of common objects in road scenes.

Preferably, a value range of dₜₕ₀ can be [300 mm, 500 mm], a value range of dₜₕ₂ can be [2500 mm, 3800 mm], a value range of dₜₕ₂ can be [30 mm, 50 mm], and a value range of dₜₕ₃ can be [42 mm, 55 mm].

Preferably, a value range of dₜₕ₄ can be ½ of the maximum measuring distance of laser radar to the maximum distance. For example, for laser radar with a ranging capacity of 200 m, the value of dₜₕ₄ can be 200,000 mm.

For example, dₜₕ₀=410 mm and dₜₕ₁=3200 mm. If |d₄−d₂|<400 mm, it is considered that the auxiliary point at the first side closest to the to-be-recognized point and the auxiliary point at the second side closest to the to-be-recognized point are located on the same object, and if 3200 mm≥|d₄−d₂|≥410 mm, it is considered that the auxiliary point at the first side closest to the to-be-recognized point and the auxiliary point at the second side closest to the to-be-recognized point are not located on the same object.

If it is determined that the auxiliary point at the first side closest to the to-be-recognized point and the auxiliary point at the second side closest to the to-be-recognized point are located on the same object in step S21, step S22 of determining that the to-be-recognized point is not an interstitial point is performed. Otherwise, step S23 of determining, based on the ranging information of a plurality of auxiliary points at the first side and the ranging information of a plurality of auxiliary points at the second side, whether the plurality of auxiliary points at the first side are located on a first object and whether the plurality of auxiliary points at the second side are located on a second object is performed. When the plurality of auxiliary points at the first side are located on the first object and the plurality of auxiliary points at the second side are located on the second object, step S24 of determining that the to-be-recognized point is an interstitial point is performed, or otherwise step S25 of determining that the to-be-recognized point is not an interstitial point is performed.

In this case, it is further determined according to a third determination threshold dₜₕ₂ whether the auxiliary points at both sides are all located on the same object.

Preferably, in step S23, it is determined, according to |d₁−d₂|<dₜₕ₂ && |d₄−d₅|<dₜₕ₂, whether the plurality of auxiliary points at the first side are located on the first object and whether the plurality of auxiliary points at the second side are located on the second object.

If |d₁−d₂|<dₜₕ₂ && |d₄−d₅|<dₜₕ₂, that is, a difference between d₁ and d₂ and a difference between d₄ and d₅ are both less than dₜₕ₂, it is considered that the plurality of auxiliary points at the first side are located on the first object and the plurality of auxiliary points at the second side are located on the second object. Since the auxiliary point at the first side closest to the to-be-recognized point and the auxiliary point at the second side closest to the to-be-recognized point are not located on the same object, and the plurality of auxiliary points at each side are located on the same object, it can be determined that the to-be-recognized point, the auxiliary points at the first side closest to the to-be-recognized point, and the auxiliary point at the second side closest to the to-be-recognized point are not isolated points, and the to-be-recognized point is neither located on the first object nor on the second object, that is, the to-be-recognized point is an interstitial point.

Conversely, if the auxiliary point on at least one side of the to-be-recognized point are not on the same object, the to-be-recognized point is not considered as an interstitial point.

For example, dₜₕ₂=39 mm. If |d₁−d₂|<39 mm && |d₄−d₅|<39 mm, it is considered that the plurality of auxiliary points at the first side are located on the first object and the plurality of auxiliary points at the second side are located on the second object, and if |d₁−d₂|≥39 mm∥|d₄−d₅|≥39 mm, it is considered that the to-be-recognized point is not an interstitial point.

If the ranging information of the plurality of auxiliary points at the first side is all 0 or the ranging information of the plurality of auxiliary points at the second side is all 0, the to-be-recognized point is not an interstitial point.

Referring to FIG. 5, as shown in FIG. 5, if (d₁=0 &&d₂=0)∥(d₄=0 && d₅=0), that is, d₁ and d₂ are both 0 or d₄ and d₅ are both 0, the to-be-recognized point is not an interstitial point. Since the ranging information of the plurality of auxiliary points at the first side is all 0 or the ranging information of the plurality of auxiliary points at the second side is all 0, it can be determined that the to-be-recognized point is not located between two objects, that is, the to-be-recognized point is not an interstitial point.

As a preferred embodiment, if the determination result is YES in step S23, and before it is determined that the to-be-recognized point is an interstitial point in step S24, step S24′ (not shown) is further performed. In step S24′, it is determined whether the to-be-recognized point, one or more auxiliary points on the first side, and one or more auxiliary points on the second side are all within the range of the maximum threshold dₜₕ₄ distance. If the determination result is YES in step S24′, it is determined that the to-be-recognized point is an interstitial point, or otherwise it is determined that the to-be-recognized point is not an interstitial point.

Referring to FIG. 5, as shown in FIG. 5, in step S24′, it is determined whether {d₁, d₂, d₃, d₄, d₅}max<dₜₕ₄. That is to say, it is determined whether the maximum value in d₁, d₂, d₃, d₄, and d₅ is less than dₜₕ₄. It can be understood that if the to-be-recognized point, the one or more auxiliary points at the first side, and the one or more auxiliary points at the second side are excessively far away, it is meaningless to determine whether the to-be-recognized point is an interstitial point.

For example, dₜₕ₄=200000 mm. If {d₁, d₂, d₃, d₄, d₅}max<200000 mm, it is considered that the to-be-recognized point, one or more auxiliary points at the first side, and one or more auxiliary points at the second side are all within the maximum threshold distance range, and if d₁≥200000 mm, d₂≥200000 mm, d₃≥200000 mm, d₄≥200000 mm, and/or d₅≥200000 mm, it is considered that at least one of the to-be-recognized point, one or more auxiliary points at the first side, and one or more auxiliary points at the second side is outside the maximum threshold distance range.

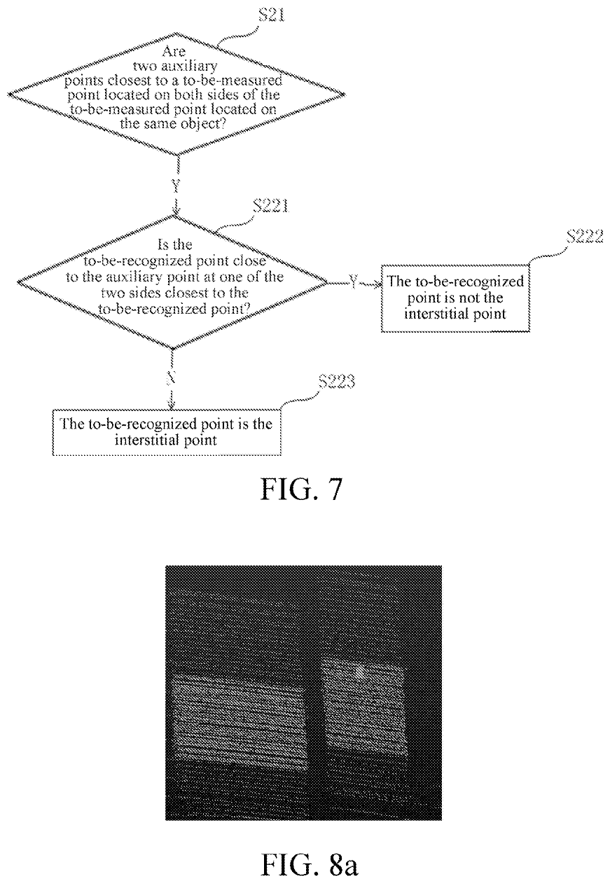

According to another preferred embodiment of this solution, as shown in FIG. 7, if the auxiliary point at the first side of the to-be-recognized point closest to the to-be-recognized point and the auxiliary point at the second side of the to-be-recognized point closest to the to-be-recognized point are located on the same object, further in step S221, it is determined, based on the ranging information of the to-be-recognized point, the ranging information of the auxiliary point at the first side closest to the to-be-recognized point, and the ranging information of the auxiliary point at the second side closest to the to-be-recognized point, whether the to-be-recognized point is close to the auxiliary point at the first side closest to the to-be-recognized point or whether the to-be-recognized point is close to the auxiliary point at the second side closest to the to-be-recognized point.

If the to-be-recognized point is close to the auxiliary point at the first side closest to the to-be-recognized point or the to-be-recognized point is close to the auxiliary point at the second side closest to the to-be-recognized point, step S222 of determining that the to-be-recognized point is not an interstitial point is performed, or otherwise step S223 of determining that the to-be-recognized point is an interstitial point is performed.

Referring to FIG. 5, as shown in FIG. 5, if (d₂+dₜₕ₃<d₃ && d₃+dₜₕ₃<d₄)∥(d₂>d₃+dₜₕ₃ && d₃>d₄+dₜₕ₃), that is, the distance d₃ of the to-be-recognized point is between d₂ and d₄, and a distance difference between d₃ and d₂ and a distance difference between d₃ and d₄ are both greater than dₜₕ₃, it is considered that the to-be-recognized point is neither close to the auxiliary point at the first side closest to the to-be-recognized point nor close to the auxiliary point at the second side closest to the to-be-recognized point, and it is determined that the to-be-recognized point is an interstitial point.

Conversely, if the to-be-recognized point is close to the auxiliary point at the first side closest to the to-be-recognized point or the to-be-recognized point is close to the auxiliary point at the second side closest to the to-be-recognized point, it can be determined that the to-be-recognized point is close to an edge of an object, and considering a small relative error, the to-be-recognized point cannot be determined as an interstitial point, so as to retain the to-be-recognized point.

For example, dₜₕ₃=45 mm. If (d₂+45 mm<d₃ && d₃+45 mm<d₄)∥(d₂>d₃+45 mm && d₃>d₄+45 mm), it is considered that the to-be-recognized point is neither close to the auxiliary point at the first side closest to the to-be-recognized point nor close to the auxiliary point at the second side closest to the to-be-recognized point. If (d₂+45 mm≥d₃ && d₃+45 mm<d₄)∥(d₂≤d₃+45 mm && d₃>d₄+45 mm), it is considered that the to-be-recognized point is close to the auxiliary point at the first side closest to the to-be-recognized point, and if (d₂+45 mm<d₃ && d₃+45 mm≥d₄)∥(d₂>d₃+45 mm && d₃≤d₄+45 mm), it is considered that the to-be-recognized point is close to the auxiliary point at the second side closest to the to-be-recognized point.

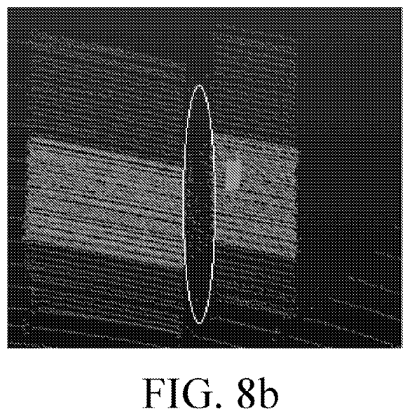

FIG. 8a is a schematic diagram of a radar point cloud in a state of enabling filtering-out of the interstitial points according to the present disclosure. FIG. 8b is a schematic diagram of a radar point cloud in a state of disabling filtering-out of the interstitial points according to the present disclosure.

As shown in FIG. 8a and FIG. 8b, in the present disclosure, by making full use of the ranging characteristics of laser radar, whether points are interstitial points is determined according to ranging information of the points, such that the interstitial points as shown in the oval in the radar point cloud can be effectively filtered out. Moreover, the logic for determination is direct, the complexity of computation is low, and the efficiency is relatively high.

According to the laser radar of the present disclosure, the points in the point cloud can be acquired one by one to perform the recognition and filtering processing of steps S1 to S4 described above. Since the determination of all points in this solution can be completed through comparison and determination of a limited number of steps, the total computational amount is relatively small and the time complexity is relatively low, so as to realize more effective determination and filtering of interstitial points in the case of limited calculation resources.

An implementation of the present disclosure further relates to a processor. The processor is configured to perform the method for filtering out the interstitial points in a radar point cloud described above.

An implementation of the present disclosure further relates to a laser radar system, including the processor described above.

It should be noted that, the method embodiments of the present disclosure can be implemented by software, hardware, firmware, and the like. Whether the present disclosure is implemented by software, hardware, or firmware, instruction codes can be stored in any type of computer-accessible memory (for example, permanent or modifiable, volatile or nonvolatile, solid or non-solid, fixed or replaceable media, and the like). Similarly, the memory may be, for example, a Programmable Array Logic (PAL), a Random Access Memory (RAM), a Programmable Read Only Memory (PROM), a Read-Only Memory (ROM), an electrically erasable programmable ROM (EEPROM), a magnetic disk, an optical disk, a Digital Versatile Disc (DVD), and so on.

It should be noted that, the units/modules mentioned in the device embodiments of the present disclosure are all logical units/modules. Physically, a logical unit may be implemented by using a physical unit, a part of a physical unit, or a combination of a plurality of physical units. The physical implementation mode of these logical units is not the most important, and the combination of functions implemented by these logical units is the key to solving the technical problems proposed by the present disclosure. In addition, in order to highlight an innovative part of the present disclosure, a unit that is not closely related to resolving the technical problems proposed in the present disclosure is not introduced into the above device implementations of the present disclosure, which does not indicate that no other units exist in the above device implementations.

It should be noted that, In the claims and specification of this patent, relational terms such as “first” and “second” are only used to differentiate an entity or operation from another entity or operation, and may not require or imply any actual relationship or sequence existing between these entities or operations. Furthermore, a term “comprise”, “include”, or any other variant is intended to encompass non-exclusive inclusion, such that a process, a method, an article, or a device including a series of elements not only includes those elements, but also includes other elements not listed explicitly, or further includes intrinsic elements of the process, the method, the article, or the device. Without more limitations, an element limited by a statement “include a/an . . . ” does not exclude additional same elements existing in the process, the method, the article, or the device including the elements.

Although the present disclosure has been illustrated and described with reference to certain preferred implementations of the present disclosure, it should be understood by a person of ordinary skill in the art that various changes in form and details may be made therein without departing from the spirit and scope of the present disclosure.

1. A method for filtering out interstitial points in a radar point cloud, the method comprising:
for a to-be-recognized point in the point cloud, acquiring, from point cloud information, ranging information of the to-be-recognized point, ranging information of one or more auxiliary points at a first side, and ranging information of one or more auxiliary points at a second side, wherein a timing span between an auxiliary point at the first side farthest away from the to-be-recognized point and the to-be-recognized point or between an auxiliary point at the second side farthest away from the to-be-recognized point and the to-be-recognized point is related to an angular resolution of a radar;
determining, based on the ranging information of the one or more auxiliary points at the first side and the ranging information of the one or more auxiliary points at the second side, whether the to-be-recognized point is an interstitial point; and
filtering out the to-be-recognized point if the to-be-recognized point is the interstitial point.

2. The method according to claim 1, wherein the timing span between the auxiliary point at the first side farthest away from the to-be-recognized point and the to-be-recognized point is equal to a number of the one or more auxiliary points at the first side times a multiple of a maximum angular resolution and a minimum angular resolution of the radar, and the timing span between the auxiliary point at the second side farthest away from the to-be-recognized point and the to-be-recognized point is equal to a number of the one or more auxiliary points at the second side times a multiple of a maximum angular resolution and a minimum angular resolution of the radar.

3. The method according to claim 1, wherein the determining, based on the ranging information of the one or more auxiliary points at the first side and the ranging information of the one or more auxiliary points at the second side, whether the to-be-recognized point is the interstitial point further comprises:
determining, based on the ranging information of the auxiliary point at the first side closest to the to-be-recognized point and the ranging information of the auxiliary point at the second side closest to the to-be-recognized point, whether the auxiliary point at the first side closest to the to-be-recognized point and the auxiliary point at the second side closest to the to-be-recognized point are located on the same object, wherein the to-be-recognized point is located between the auxiliary point at the first side closest to the to-be-recognized point and the auxiliary point at the second side closest to the to-be-recognized point; and
if the auxiliary point at the first side closest to the to-be-recognized point and the auxiliary point at the second side closest to the to-be-recognized point are located on the same object, the to-be-recognized point is not the interstitial point.

4. The method according to claim 3, wherein if a distance of a to-be-recognized point is between a distance corresponding to the auxiliary point at the first side closest to the to-be-recognized point and the distance corresponding to an auxiliary point at the second side closest to the to-be-recognized point, the to-be-recognized point is located between the auxiliary point at the first side closest to the to-be-recognized point and the auxiliary point at the second side closest to the to-be-recognized point.

5. The method according to claim 3, wherein if the auxiliary point at the first side closest to the to-be-recognized point and the auxiliary point at the second side closest to the to-be-recognized point are not located on the same object,
it is determined based on the ranging information of a plurality of auxiliary points at the first side and the ranging information of a plurality of auxiliary points at the second side whether the plurality of auxiliary points at the first side are located on a first object and whether the plurality of auxiliary points at the second side are located on a second object; and
if the plurality of auxiliary points at the first side are located on the first object and the plurality of auxiliary points at the second side are located on the second object, the to-be-recognized point is the interstitial point.

6. The method according to claim 5, wherein if the ranging information of the plurality of auxiliary points at the first side is all 0 or the ranging information of the plurality of auxiliary points at the second side is all 0, the to-be-recognized point is not the interstitial point.

7. The method according to claim 1, wherein the to-be-recognized point, the one or more auxiliary points at the first side, and the one or more auxiliary points at the second side are all within a maximum threshold distance.

8. The method according to claim 3, wherein if the auxiliary point at the first side of the to-be-recognized point closest to the to-be-recognized point and the auxiliary point at the second side of the to-be-recognized point closest to the to-be-recognized point are located on the same object,
it is determined based on the ranging information of the to-be-recognized point, the ranging information of the auxiliary point at the first side closest to the to-be-recognized point, and the ranging information of the auxiliary point at the second side closest to the to-be-recognized point whether the to-be-recognized point is close to the auxiliary point at the first side closest to the to-be-recognized point or whether the to-be-recognized point is close to the auxiliary point at the second side closest to the to-be-recognized point; and
if the to-be-recognized point is close to the auxiliary point at the first side closest to the to-be-recognized point or the to-be-recognized point is close to the auxiliary point at the second side closest to the to-be-recognized point, the to-be-recognized point is not the interstitial point.

9. The method according to claim 1, wherein all points in the point cloud are successively used as the to-be-recognized point to perform the steps of the above method for recognition.

10. A processor, configured to perform the method of filtering out interstitial points in a radar point cloud according to claim 1.

11. A laser radar, comprising:
a transmitting device, configured to transmit a laser detection beam; and
a receiving device, configured to receive the detection beam and perform photoelectric conversion to obtain a corresponding point cloud,
wherein the laser radar further comprises the processor according to claim 10 to perform the method for filtering out interstitial points in a radar point cloud based on the point cloud.
